(19) United States
(12) Patent Application Publication
(10) Pub. No.: US 2016/0011064 A1
(43) Pub. Date: Jan. 14, 2016

(54) IMPACT SENSING BALLISTIC VEST AND METHOD FOR COMMUNICATING DATA THEREOF

(71) Applicants: Joseph Maybank, Bedford Hills, NY (US); William K. Broman, Grosse Pointe Woods, MI (US)

(72) Inventors: Joseph Maybank, Bedford Hills, NY (US); William K. Broman, Grosse Pointe Woods, MI (US)

(21) Appl. No.: 14/691,878

(22) Filed: Apr. 21, 2015

Related U.S. Application Data
(60) Provisional application No. 61/982,310, filed on Apr. 21, 2014.

(51) Int. Cl. G01L 5/00; G01B 21/00; F41H 1/02; G06F 19/00

(52) U.S. Cl. CPC G01L 5/0052; G06F 19/345; G01B 21/00; F41H 1/02

(57) ABSTRACT

A system for detecting impact on a ballistic vest and determining the extent, if any, of penetration and a resulting trajectory through a wearer of the ballistic vest. The ballistic vest is operable to communicate data to a mobile device to determine which organs have experienced trauma. Data is collected by sensor panels on the ballistic vest for analysis and to calculate the resulting trajectory. The resulting trajectory is correlated to organ locations to determine the potential internal damage to the wearer.

### CROSS REFERENCE TO RELATED APPLICATION

This application claims the priority of U.S. Provisional Application No. 61/982,310, entitled “IMPACT SENSING BALLISTIC VEST AND METHOD FOR COMMUNICATING DATA THEREOF,” filed on Apr. 21, 2014, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The invention described herein generally relates to detecting an impact on a ballistic vest and more specifically, to determine an extent of penetration, if any, and a resulting trajectory through a wearer of the ballistic vest.

2. Description of the Related Art

Police and military personnel wear ballistic vests for protection from projectiles intended to inflict harm. In mass casualty incidences with limited emergency medical resources, leaders are often faced with the daunting task of determining who must be treated first. In remote or economically depressed regions, resources are limited and police patrols are routinely conducted solo.

While ballistic vests offer protection from an array of projectiles, one drawback is that if the vest is penetrated, it becomes very difficult to determine the location of the impact, let alone to quickly determine the level of penetration and path of the projective. Pain experienced by a wearer of a ballistic vest from impact may not indicate whether a projectile has penetrated through the vest. Identifying the level of trauma inflicted on the wearer is difficult over a distance if the wearer is not capable of communicating to a concerned party (e.g., if the wearer is unconscious). This problem is amplified if a plurality of injured personnel is at a distance from each other, and there is a single medical response team.

There is thus a need to assess the level of trauma inflicted on a wearer of a ballistic vest without the need for the wearer to be conscious or capable of active communication. Another requirement is that the extent of injuries be reported to a central point for analysis.

### SUMMARY OF THE INVENTION

The present invention provides a ballistic vest comprising ballistic material configured between sensor panels, the sensor panels including sensor configured to trigger impact signals, a processor configured to identify the impact signals from the sensor panels, and determine locations of impacts on given ones of the sensor panels, and a communication module configured to transmit data comprising the location of the impacts on the given ones of the sensor panels to a mobile device.

The sensor may include horizontal and vertical signal lines connected to the processor. The processor is operable to monitor breakage of the horizontal and vertical signal lines connected to the processor. In a further embodiment, the processor is operable to determine the locations of impacts based on the breakage of the horizontal and vertical signal lines. According to another embodiment, the sensors may include sensor patches. The processor may further monitor breakage of the sensor patches and determine the locations of impacts based on the breakage of the sensor patches.

In one embodiment, the determined locations of impacts on the given ones of the sensor panels include (X,Y) coordinates. The processor may be further operable to penetration of the ballistic material based on the identification of the impact signals from the consecutive ones of the sensor panels.

The ballistic vest, in certain embodiments, may further comprise sensors for passive vital sign monitoring to monitor at least one of heart rate, breathing rate, and blood pressure. The data comprising the location of the impacts on the sensor panels may also include identifiers of at least one of the given ones of the sensor panels, the sensors, and sensor panel layers.

According to another aspect of the present invention, an apparatus is provided for analyzing impact on a ballistic vest. The apparatus comprises a host device comprising a vest communication module configured to receive data comprising a location of impact on sensor panels of the ballistic vest, a processor, a memory having executable instructions stored thereon that when executed by the processor cause the processor to calculate trajectory of the impact on the ballistic vest based on the location of impact on the sensor panels of the ballistic vest, and determine organ damage based on the data comprising the location of the impact on the sensor panels of the ballistic vest and the trajectory of the impact on the ballistic vest. The apparatus further comprises a user communication module configured to transmit notification data including the organ damage to a monitoring device.

In one embodiment, the vest communication module is further operable to communicate, wired or wirelessly, with a communication module corresponding to the ballistic vest. The location of impact on the sensor panels of the ballistic vest may include (X,Y) coordinates associated with the sensor panels of the ballistic vest. The notification data may further include the trajectory of the impact on the ballistic vest, the location of the impact on the sensor panels of the ballistic vest, impact force measurements, and body vital signals.

The user communication module may either transmit the notification data via push or pull communications with the monitoring device. In certain embodiments, the user communication module is operable to receive identifiers of at least one of the sensor panels, grids, patches and layers.

Another aspect of the invention provides for a system for detecting impact on a ballistic vest, the system comprising a ballistic subsystem including ballistic material and sensor panels configured to determine a location of impact on the ballistic material, and transmit the location of the impact on the ballistic material to a host device, the host device configured to establish a wired or wireless network connection with the ballistic subsystem, receive data comprising the location of impact on the ballistic material, calculate trajectory of the impact on the ballistic material, determine organ damage based on the data comprising the location of the impact on the ballistic material and the calculated trajectory of the impact on the ballistic material, and transmit notification data comprising the organ damage to a monitoring device.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates exemplary input and output of an impact sensing ballistic vest system according to an embodiment of the present invention;

FIG. 2A and FIG. 2B illustrate front views of a vest subsystem according to embodiments of the present invention;

FIG. 3 illustrates a top view of a vest subsystem according to an embodiment of the present invention;

FIG. 4 illustrates a flowchart of operations performed by an impact sensing ballistic vest system according to an embodiment of the present invention;

FIG. 5 illustrates a diagram of subsystems and modules of an impact sensing ballistic vest system according to an embodiment of the present invention;

FIG. 6 illustrates a flowchart of operations of a mobile device subsystem according to an embodiment of the present invention; and

FIG. 7 illustrates a system for data transmissions according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

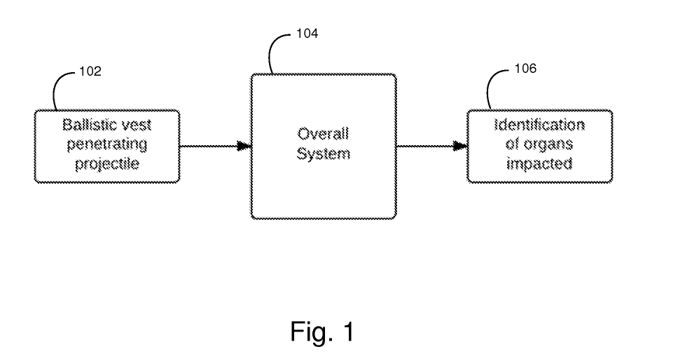

FIG. 1 presents exemplary input and output of an impact sensing ballistic vest system according to an embodiment of the present invention. Overall system 104 may comprise an impact sensing ballistic vest including a vest subsystem and a mobile device subsystem (host device). A plurality of users may be involved for usage of the overall system 104. For example, a first user can be the bearer of overall system 104 (e.g., wearer of the impact sensing ballistic vest), and second users may be individuals within an organization or a medical response team who may monitor the status of the ballistic vest via communication with the mobile device subsystem. The vest subsystem may include a ballistic vest with sensor panels for detecting a penetrating projectile (input 102).

Input 102 to the overall system 104 can be a detection of (or a signal resulting from) a projectile impacting and/or penetrating the vest subsystem. The input 102 may be received by the vest subsystem, processed, and used to communicate an output 106 to the mobile device subsystem. The mobile device subsystem may either be integrated with the vest subsystem or carried separately (e.g., worn in a holster, carried in a pocket, pouch, or backpack, strapped to the body, embedded in the wearer, etc.). The mobile device subsystem may comprise a portable computing device (e.g., personal digital assistant (PDA), cell phone, smartphone, tablet computer, e-book reader, a smart watch/wearable device, or any computing device having a central processing unit and memory unit capable of connecting to a network). The portable computing device may vary in terms of capabilities or features. For example, a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display. A portable computing device may also include or execute an application to communicate content, such as, for example, textual content, multimedia content, or the like. The portable computing device may include or execute a variety of operating systems, including a personal computer operating system, such as a Windows, Mac OS or Linux, or a mobile operating system, such as iOS, Android, or Windows Mobile, or the like. The portable computing device may include or may execute a variety of possible applications, such as a client software application enabling communication with other devices, such as communicating one or more messages, such as via email, short message service (SMS), or multimedia message service (MMS), including via a network.

The output 106 includes an identification of organs impacted. For example, output 106 may comprise a list of organs that may have experienced trauma if a projectile has entered the human body (e.g., piercing through the vest subsystem). Output 106 can be transmitted from overall system 104 via the mobile device subsystem to a second party on a remote system. The remote system may be a client device, a monitoring system, or server at a centralized or headquarter location such as a dispatch station or a command center. For example, second users may be capable of, but not limited to, receiving output 106 via push notifications from the overall system 104 when an impact has been detected or when a sensor on the sensor panels in the vest subsystem has been punctured. In an alternative embodiment, second users may retrieve information, status of overall system 104, or notifications via pull communication. The notifications may include organs that may have been affected from an impact or penetration, as well as the percentage of organ that has been impacted by the path of the projectile. Additional information may also be included in the notifications such as ballistic vest condition/damage, locations of sensor damage, impact locations, health vitals, etc.

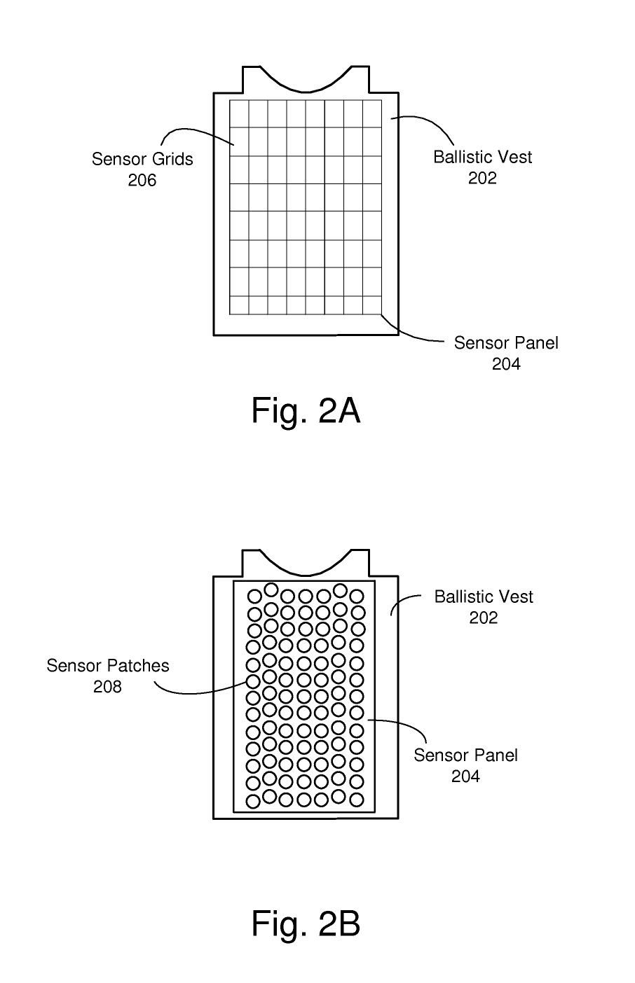

FIG. 2A presents a front view of a vest subsystem according to an embodiment of the present invention. The vest subsystem includes ballistic vest 202 and sensor panel 204. Ballistic vest 202 may be designed with any soft body armor material, such as Kevlar, although the design is also be suitable for hard body armor as well. The present invention is not limited to vests, and in other embodiments, the vest subsystem and other components of the overall system 104 may be applied to jackets, plating, padding, helmets, and various other protective gear as well as non-armor applications.

The sensor panel 204 is operable to determine locations of impacts as well as (X,Y) coordinates of breakage via sensor grids 206. The sensor panel 204 can include overlapping layers of polyimide (or any other suitable material) with sensor grids 206 printed, or otherwise affixed on sensor panel 204. In an exemplary design, sensor panel 204 may be composed of grid sections made up of signal lines on each axis. The grid may be designed with, for example, horizontal and vertical lines so the full area of the vest can be covered with input lines. Grid design patterns may include uniform, rectilinear, curvilinear, diamond, honeycomb, and spider web, to name a few.

Each grid, one to determine the location on the x axis and the other to determine the location on the y axis, can be fed into a pull down resistor network and be connected to an input on a microcontroller within ballistic vest 202. The microcontroller may cycle through the inputs and test for “HIGH” voltages, greater than a specified voltage (see code in appendix for an exemplary method). If the signal line that feeds into an input line is broken, the microcontroller can sense a “LOW” voltage and send the location of the broken line on to a communication module of the vest subsystem to communicate the breakage (e.g., to the mobile device subsystem). The lines may be configured to be close enough apart that they would be broken by all ammunition types. As the smallest diameter bullet currently in common use is the NATO 5.56 mm, according to the NATO Standardization Agency, the system can be designed with 1 mm thick lines 3 mm apart, such that a full line would be broken regardless of where on the panel the projectile impacted. An exemplary sensor panel 204 may be 20 cm wide and 30 cm tall, based on large size uniform specified in Army Regulation 670-1. The overall size of the grid can be, for example, 20 cm by 30 cm broken down into 64 sections, 25 mm by 35 mm. The sensor panel 204 can be constructed in smaller or larger sizes to fit other applications. This will allow the sensor panel 204 to cover the majority of vital organs.

FIG. 2B presents a front view of a vest subsystem according to another embodiment of the present invention. In this embodiment, the sensor panel 204 includes sensor patches 208. Similar to the embodiment described with reference to FIG. 2A, sensor panel 204 is operable to determine locations of impacts and penetrations as well as (X,Y) coordinates via sensor patches 208. Sensor patches 208 may be communicatively connected to a microcontroller or processing device configured to detect breakage or triggering of the sensor patches 208. The sensor patches 208 may be constructed according to various shapes or sizes and may vary in certain areas of ballistic vest 202 depending on the granularity and precision that may be required for certain body areas. Sensor patches 208 may include shapes such as circles, ovals, diamonds, squares, triangles, polygons, etc.

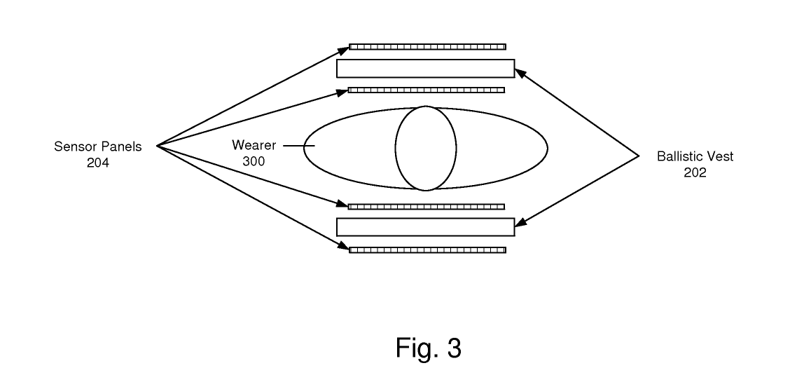

FIG. 3 presents a top view of a vest subsystem according to an embodiment of the present invention. The vest subsystem may comprise one or more layers of ballistic material woven or otherwise configured in a garment or accessory article. In the illustrated embodiment, the top view includes a human torso (wearer 300) in between two layers (front and rear of the human torso) of ballistic material (ballistic vest 202) outfitted with sensor panels 204 to detect projectile impact and/or penetration. The front and rear layers of ballistic material are each fitted (or “sandwiched”) between two sensor panel 204 layers. Through the use of a plurality of sensor panels 204, the impact sensing ballistic vest (e.g., overall system 104) is able to trace a level of penetration and an estimated trajectory of a projectile (or weapon) through the wearer's body as well as identify affected internal organs.

The sensor panels 204 may comprise a plurality of panels, each panel including two grid or patch layers, along the X and Y-axis. The sensor panels 204 can be layered on the inside and outside of a layer of bullet proof material to allow the system to determine the difference between, for example, an impact, a simple penetration and a “through and through.” For example, a direct impact or penetration of two consecutive sensor panels may indicate a penetration through ballistic material between the two consecutive sensor panels. Such a construction provides additional information about the severity of a hit to wearer 300, as well as the location of the impact. Each sensor panel 204 is operable to communicate to a mobile device subsystem individually, so a damaged panel may not render the overall system nonoperational. An individual sensor panel 204 may transmit its own data to a microcontroller (e.g., mobile device subsystem), using its own power supply, and a wired or wireless communication interface (such as Bluetooth communicator).

Each panel 204 may comprise a plurality of sensors, each sensor, for example, comprising grid or patch layers in an X and Y-axis. In this instance, a given panel may be able to detect multiple impacts on different areas of the panel, that is, at least one impact per sensor. Moreover, a single microcontroller may control multiple sensor panels 204. For instance, a single microcontroller may control the pair of panels on the front of the wearer 300 whereas a second microcontroller may control the pair of panels on the rear of the wearer 300. Each sensor panel 204 can essentially act as a separate system; it can communicate a serial number and layer number to the mobile device subsystem via a wired, short-range wireless or Bluetooth communicator, along with information about the location of the penetration. The mobile device subsystem may then determine the extent of penetration based on which panels the system indicates have been broken.

Sensor grids or panels can be created by printing copper lines on a polyimide sheet or fiberglass or other woven sheet clad, for example, one side for the x-axis and the other for the y-axis. Ballistic vest 202 may be made with multiple ballistic panels, each made of multiple layers of ballistic material, strategically placed on the garment. In this instance, the copper or other conductor lines may be woven in the outer layers of the multilayer ballistic panel. Microcontrollers, circuitry, chips, and batteries may be attached to the sheet with copper rivets and solder which may then be covered in clear plastic adhesive to prevent accidental breakage and short circuits.

Sensor panels 204 may also include shock, vibration, or force detectors, sensors and data recorders. In at least one embodiment, the impact sensor may provide feedback to a user (wearer 300 or second users) about whether a bullet or other projectile has hit the vest and measure the force of the impact. In this instance, the fabric with the sensors woven into it may be placed on the inside (the side facing the chest of the user) or similarly outside of the vest opposite the chest of the user. When impacted the ballistic vest material or polyethylene sheets of the vest deform to “catch” the bullet or projectile. This deformation may be measured to compute there from the force of impact, and whether a bullet has gone all the way through the vest (e.g., broken through multiple sensor panels 204). Additionally, sensors woven into the fabric of the vest subsystem may give the user information on where the impact took place, and what vital organs may possibly have been damaged based on force and location of impact. The ballistic vest subsystem may also include additional sensors for passive vital sign monitoring to monitor, for example, heart and breathing rate, and blood pressure. These vital signs can be reported back to a user such that the health of the wearer 300 can be monitored, and the information can be used in further research surrounding the body's response to high stress situations.

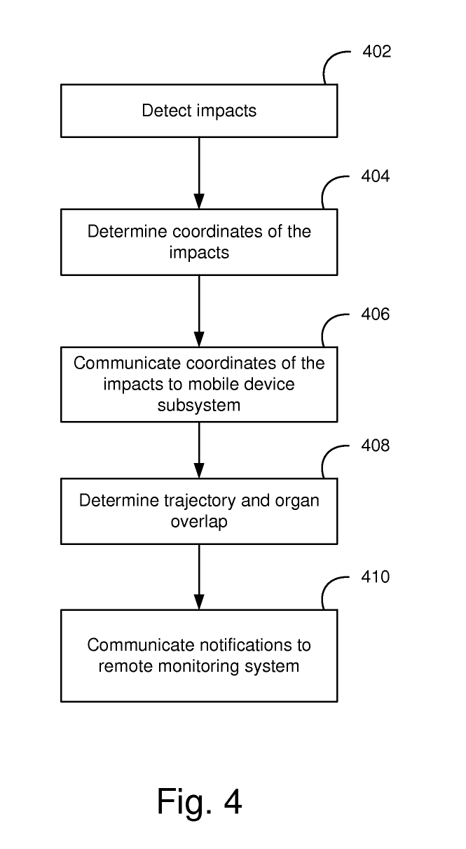

FIG. 4 presents a flowchart of operations performed by an impact sensing ballistic vest system according to an embodiment of the present invention. Impacts are detected by the impact sensing ballistic vest system, step 402. The impacts may be detected by sensor panel(s) of the vest subsystem of the impact sensing ballistic vest system. An impact may include any of blows, piercings, and damage to the vest subsystem and/or the wearer. Signals or voltages from sensor grids may be triggered by impact events and transmitted to one or more processing devices or microcontrollers within the sensor panels. In another embodiment, the processing devices or microcontrollers may poll the sensor grids for signals or voltages indicative of an impact.

Coordinates of the impacts are determined, step 404. For example, ‘X’ and ‘Y’ coordinates of the impacts are determined by the sensor panels of the vest subsystem. The signals or voltages may be used to determine the coordinates of the impacts by identifying grid or patch locations associated with the signals. According to one embodiment, the signals or voltages may be associated with serial numbers or identifiers of panel sensors, grids, patches and/or layers. In a further embodiment, a lookup table may be used to determine coordinates from the signals or voltages.

Coordinates of impacts are communicated to a mobile device subsystem, step 406. The mobile device subsystem is operable to receive inputs (projectile impacts) from the vest subsystem. A communication module of the vest subsystem may be configured to communicate wirelessly with a host mobile device (the mobile device subsystem). The communication module may comprise a wired, wireless, or Bluetooth device specifically designed or programmed to operate with the microcontrollers/processors of the sensor panels. As an example, the communication module can receive the (X, Y) coordinates of a penetration from the sensor panels (e.g., as an int) and send the signal (e.g., as an int). Additionally, the communication module is operable to send a serial number or identifier with the (X, Y) coordinates (e.g., as an int) so the mobile device subsystem can be able to determine which layer was penetrated.

Trajectory and organ overlap are determined, step 408. The mobile device subsystem can be configured to determine a trajectory and organ overlap based on the coordinates of impacts. An estimated trajectory may be calculated and compared with a database of organ locations. The database may include an index of coordinates associated with organ locations.

Notifications are communicated to a remote monitoring system, step 410. The notifications are communicated to a remote monitoring system to alert second users of injuries and potentially impacted organs of a wearer of the impact sensing ballistic vest system. The mobile device subsystem may transmit the notifications via push or pull communications with one or more devices of the remote monitoring system. A remote monitoring system may comprise a system configured to monitor one or more impact sensing ballistic vest systems. Notifications may include the trajectory and organ overlap, the coordinates of impacts, and any other statistics such as impact measurements and wearer body vital signals.

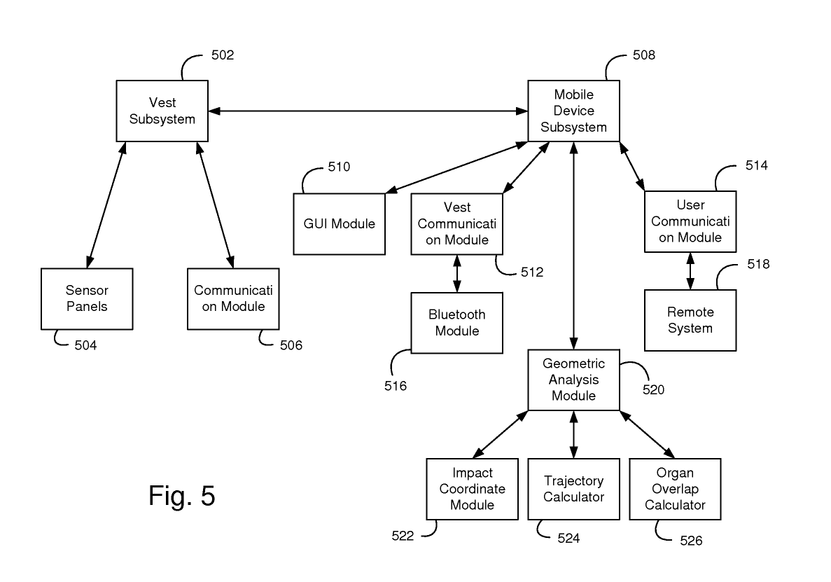

FIG. 5 presents an impact sensing ballistic vest system according to an embodiment of the present invention. The impact sensing ballistic vest system comprises two subsystems—the vest subsystem 502 and the mobile device subsystem 508. The two subsystems are separated by a network connection, which in this example, is a Bluetooth connection. Other types of wireless or wired network communication technologies known by one of ordinary skill in the art may also be used to communicate data between the two subsystems.

Vest communication module 512 comprises Bluetooth (or any other wireless network technology) module 516. Bluetooth module 516 includes communication hardware or circuitry that provides a Bluetooth/wireless connection with the microcontrollers on the sensor panels 504 of the vest subsystem via communication module 506. The Bluetooth module 516 is operable to accept communication from the communication module 506 of the vest subsystem 502. The Bluetooth module 516 may be developed through the use of, for example, the Android Bluetooth API. Mobile device subsystem 508 is able to connect to communication module 506 and accept data transferred from the microcontrollers of the sensor panels 504. The mobile device subsystem 508 may be treated as a client, and the microcontrollers of the vest subsystem 502 or the vest subsystem 502 as an entirety may be treated as the server.

The mobile device subsystem 508 comprises a graphical user interface module 510, vest communication module 512, geometric analysis module 520, and user communication module 514. GUI module 510 may comprise computer program code stored on a memory device that when executed by a processor of the mobile device subsystem 508 causes the processor to provide and/or customize a user interface, or user experience, to facilitate use of the vest subsystem 502 with mobile device subsystem 508.

The geometric analysis module 520 is capable of receiving or accepting (X, Y) coordinates from the communication module 506 of the vest subsystem 502 and analyzing the coordinates by calculating a trajectory of a projectile through the ballistic vest. Receiving the (X, Y) coordinates at impact coordinate module 522 occurs through accessing data received by the Bluetooth module 516. The geometric analysis module 520 may also determine and/or compute the angle of trajectory using trajectory calculator 524, as well as the percentage of overlap of the projectile's path with organs in the human torso or body via organ overlap calculator 526.

According to one embodiment, analysis may occur using a database with pre-calculated trajectories. This approach may be used when the ballistic vest has a limited number of zones (e.g., 64) on each sensor panel, however, in an alternative embodiment, the trajectory may be calculated in real time instead via trajectory calculator 524. Trajectories may be calculated using trigonometric equations,

$$y = {R}_{x} sin {θ}_{1} , \\ x = {R}_{x} cos {θ}_{1} , \\ z = {R}_{y} cos {θ}_{2} , and$$

$${θ}_{3} = {cos}^{- 1} \frac{\sqrt{{x}^{2} + {y}^{2}}}{\sqrt{{x}^{2} + {y}^{2} + {z}^{2}}} .$$

However, in another embodiment, one can assume that all layers are on one plane and eliminate the z-axis. A regression may be performed on available data points to determine the slope of a best-fit line. The geometric analysis module 520 may then search a grid of values (e.g., 8×8) and compare the slopes of each point and the end-points. If one of these slopes is within 25% of the slope of the best-fit line, that point is added to an array of injured organs. Further, each point to the left and right on the x-axis can also added to increase the area that may have experienced trauma. Once the trajectory has been determined the geometric analysis module 520 is able identify what organs have experienced trauma (and potential internal damage to the individual impacted by a projectile) as well as calculate a percentage of one or more organs that has been impacted by the path of the projectile via organ overlap calculator 526.

According to an alternative embodiment, a percentage of organs impacted by the patch of the projected may be identified based on a database of organ locations. The database of organ locations may be created using basic human anatomy. Vest zones may be constructed using transverse sagittal planes. In an exemplary embodiment, the database of organ locations may contain information of sets for a plurality of zones. The zones can be constructed using the transverse and sagittal planes based on specific dimensions of the human torso.

The user communication module 514 is capable of communicating and sending notifications to second users at remote system 518 for monitoring the impact sensing ballistic vest system over a network. The network may be any suitable type of network allowing transport of data communications across thereof. The network may couple devices so that communications may be exchanged, such as between a server and a client device or other types of devices, including between wireless devices coupled via a wireless network, for example. In one embodiment, the network may be the Internet, following known Internet protocols for data communication, or any other communication network, e.g., any local area network (LAN), or wide area network (WAN) connection, wire-line type connections, wireless type connections, or any combination thereof. The user communication module may alert second users that there has been a penetration in a vest monitored by a ballistic vest software application via notifications. According to one embodiment, notifications to the second user may be made in-app. The push notifications may be messages delivered directly from the mobile device subsystem 508 to ballistic vest software installed at remote system 518. In another embodiment, push notifications may be received at remote system 518 as SMS, email, or other electronic messages such as Google Cloud Messaging.

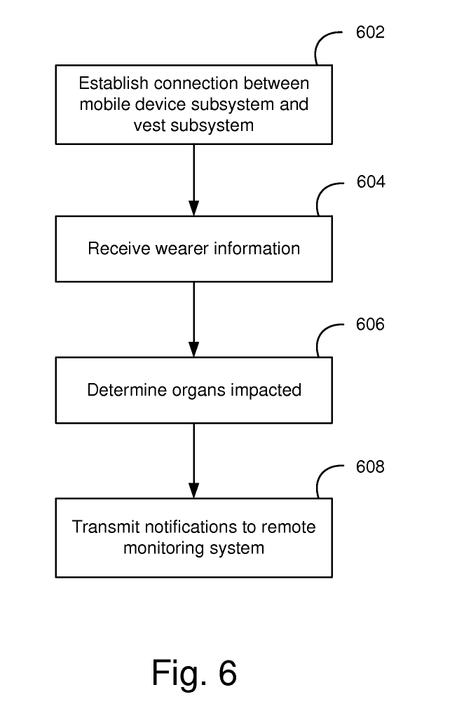

FIG. 6 presents a flowchart of operations of a mobile device subsystem according to an embodiment of the present invention. The wearer of an impact sensing ballistic vest system may activate and enable a mobile device subsystem (e.g., a host device) for use with a vest subsystem (e.g., impact sensing ballistic vest). A connection is established between mobile device subsystem and vest subsystem, step 602. Using the mobile device subsystem, a Bluetooth or wireless connection may be initiated with the vest subsystem to connect the mobile device subsystem with the vest subsystem.

Wearer information is received, 604. The mobile device subsystem may include a ballistic vest software application where the wearer may select a “wearer mode” and input a unique identifier into the mobile device subsystem. The unique identifier may be used to identify the person and any other personal information associated with person who is wearing the ballistic vest. Personal information may include name, sex, age, blood type, or any other information that may be helpful to medical or emergency personnel. While in the “wearer mode,” the impact sensing ballistic vest system is ready for operation.

Organs that have been impacted from impact are determined, step 606. Upon impact (or vest penetration), the impact sensing ballistic vest system can determine what organs were impacted and send notifications to remote systems and devices configured to receive the notifications from the impact sensing ballistic vest system (e.g., of second users).

Notifications are transmitted to a remote monitoring system, step 608. Second users may monitor the impact sensing ballistic vest system by operation of ballistic vest software on their device(s). The second users may be notified of vest penetration for any vest tracked and logged by monitoring devices configured with software for monitoring the impact sensing ballistic vest system. For example, a second user may select and enable a “monitoring state” configuration for the monitoring software to start receiving notification transmissions from the vest system. Monitoring devices may comprise general purpose computing devices (e.g., personal computers, mobile devices, terminals, laptops, personal digital assistants (PDA), cell phones, tablet computers, or any computing device having a central processing unit and memory unit capable of connecting to a network.

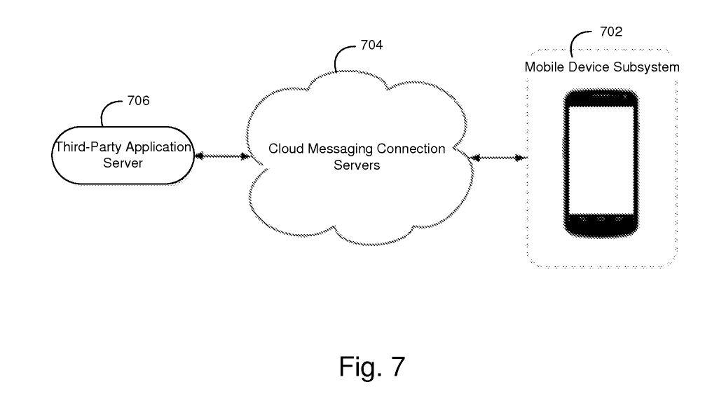

FIG. 7 presents a system for data transmissions according to an embodiment of the present invention. In the illustrated embodiment, mobile device subsystem 702 may be employed with the use of cloud messaging connection servers 704 to distribute notification messages to second users. An example of a cloud messaging connection server may be a Google Cloud Messaging (GCM) service used by Android devices. The cloud messaging connection servers 704 are operable to enable push notifications across many devices. Further, a third-party application server 706 may be used to distribute notification messages to ballistic vest software applications (installed on mobile device subsystem 702) used by the second users to monitor the impact sensing ballistic vest system.

FIGS. 1 through 7 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

APPENDIX A
Application Pseudocode - Geometric Analysis

package com.example.geoanalysis;
import android.app.Activity;
public class GeometricAnalysisActivity extends Activity {

//Variables declared here
public void onCreate(Bundle savedInstanceState){

super.onCreate(savedInstanceState);
setContentView(R.layout.activity_geoanalysis);

}
public void readInput( ){

//Use getInputStream( ) and read[byte( )]

}
public void calculateTrajectory( ){

//Match integers from readInput( ) with database
//Use if statements to determine what panel was hit
if(layerPenetrated1==1){

if(layerPenetrated2==1){

if(layerPenetrated3==1){

if(layerPenetrated4==1){
}else{
}

}else{
}

}else{
}

}else{
}

}

}

APPENDIX B
Sensor Panel Control Code

| | |
|---|---|
| int r0 = 0; | //value of select pin at the 4051 (s0) |
| int r1 = 0; | //value of select pin at the 4051 (s1) |
| int r2 = 0; | //value of select pin at the 4051 (s2) |

| | |
|---|---|
| int xcount = 0; | //which y pin we are selecting |

int ycount = 0;
int xval = HIGH;
int yval = HIGH;
void setup( ){

| | |
|---|---|
| pinMode(2, OUTPUT); | // xs0 |
| pinMode(3, OUTPUT); | // xs1 |
| pinMode(4, OUTPUT); | // xs2 |
| pinMode(5, OUTPUT); | // ys0 |
| pinMode(6, OUTPUT); | // ys1 |
| pinMode(7, OUTPUT); | // ys2 |

| | |
|---|---|
| pinMode(8, INPUT); | //X |
| pinMode(9, INPUT); | //Y |

Serial.begin(9600);

}
void loop ( ) {

for (xcount=0; xcount<=7; xcount++) {

// select the bit
r0 = bitRead(xcount,0);
r1 = bitRead(xcount,1);
r2 = bitRead(xcount,2);
if(r0==0) r0 = LOW;
if(r0==1) r0 = HIGH;
if(r1==0) r1 = LOW;
if(r1==1) r1 = HIGH;
if(r2==0) r2 = LOW;
if(r2==1) r2 = HIGH;
digitalWrite(2, r0);
digitalWrite(3, r1);
digitalWrite(4, r2);
xval = digitalRead(8);
delay(100);
if (xval == LOW){

Serial.print(“X”);
Serial.print(xcount);
break;

}

}
for (ycount=0; ycount<=7; ycount++) {

// select the bit
r0 = bitRead(ycount,0);
r1 = bitRead(ycount,1);
r2 = bitRead(ycount,2);
if(r0==0) r0 = LOW;
if(r0==1) r0 = HIGH;
if(r1==0) r1 = LOW;
if(r1==1) r1 = HIGH;
if(r2==0) r2 = LOW;
if(r2==1) r2 = HIGH;
digitalWrite(5, r0);
digitalWrite(6, r1);
digitalWrite(7, r2);
yval = digitalRead(9);
delay(100);
if (yval == LOW){

Serial.print(“Y”);
Serial.print(yco unt);
break;

}

}

}

What is claimed is:

1. A ballistic vest comprising:
ballistic material configured between sensor panels;
the sensor panels including sensors configured to trigger impact signals;
a processor configured to identify the impact signals from the sensor panels, and determine locations of impacts on given ones of the sensor panels; and
a communication module configured to transmit data comprising the location of the impacts on the given ones of the sensor panels to a mobile device.

2. The ballistic vest of claim 1 wherein the sensors include horizontal and vertical signal lines connected to the processor.

3. The ballistic vest of claim 2 wherein the processor is further operable to monitor breakage of the horizontal and vertical signal lines connected to the processor.

4. The ballistic vest of claim 3 wherein the processor is further operable to determine the locations of impacts based on the breakage of the horizontal and vertical signal lines.

5. The ballistic vest of claim 1 wherein the determined locations of impacts on the given ones of the sensor panels include (X,Y) coordinates.

6. The ballistic vest of claim 1 wherein the sensors include sensor patches.

7. The ballistic vest of claim 6 wherein the processor is further operable to monitor breakage of the sensor patches.

8. The ballistic vest of claim 7 wherein the processor is further operable to determine the locations of impacts based on the breakage of the sensor patches.

9. The ballistic vest of claim 1 wherein the processor is further operable to:
identify impact signals from consecutive ones of the sensor panels; and
determine a penetration of the ballistic material based on the identification of the impact signals from the consecutive ones of the sensor panels.

10. The ballistic vest of claim 1 further comprising sensors for passive vital sign monitoring to monitor at least one of heart rate, breathing rate, and blood pressure.

11. The ballistic vest of claim 1 wherein the data comprising the location of the impacts on the sensor panels includes identifiers of at least one of the given ones of the sensor panels, the sensors, and sensor panel layers.

12. An apparatus for analyzing impact on a ballistic vest, the apparatus comprising:
a host device comprising:
a vest communication module configured to receive data comprising a location of impact on sensor panels of the ballistic vest;
a processor;
a memory having executable instructions stored thereon that when executed by the processor cause the processor to:
calculate trajectory of the impact on the ballistic vest based on the location of impact on the sensor panels of the ballistic vest, and
determine organ damage based on the data comprising the location of the impact on the sensor panels of the ballistic vest and the trajectory of the impact on the ballistic vest; and
a user communication module configured to transmit notification data including the organ damage to a monitoring device.

13. The apparatus of claim 12 wherein the vest communication module is further operable to communicate with a communication module corresponding to the ballistic vest.

14. The apparatus of claim 13 wherein communication between the vest communication module and the communication module corresponding to the ballistic vest is at least one of a wired and wireless connection.

15. The apparatus of claim 12 wherein the location of impact on the sensor panels of the ballistic vest includes (X,Y) coordinates associated with the sensor panels of the ballistic vest.

16. The apparatus of claim 12 wherein the notification data further includes the trajectory of the impact on the ballistic vest, the location of the impact on the sensor panels of the ballistic vest, impact force measurements, and body vital signals.

17. The apparatus of claim 12 wherein the user communication module is further operable to transmit the notification data via at least one of push and pull communications with the monitoring device.

18. The apparatus of claim 12 wherein the user communication module is operable to receive identifiers of at least one of the sensor panels, grids, patches, and layers.

19. A system for detecting impact on a ballistic vest, the system comprising:
a ballistic subsystem including ballistic material and sensor panels configured to determine a location of impact on the ballistic material, and transmit the location of the impact on the ballistic material to a host device;
the host device configured to:
establish a wireless network connection with the ballistic subsystem,
receive data comprising the location of impact on the ballistic material,
calculate trajectory of the impact on the ballistic material,
determine organ damage based on the data comprising the location of the impact on the ballistic material and the calculated trajectory of the impact on the ballistic material, and
transmit notification data comprising the organ damage to a monitoring device.
